(19) United States
(12) Patent Application Publication
(10) Pub. No.: US 2026/0278675 A1
(43) Pub. Date: Sep. 17, 2026

(54) GENERATING CREDIT CAPACITY ESTIMATES

(71) Applicant: Royal Bank of Canada, Toronto (CA)

(72) Inventors: Seyed Hossein Hajimirsadeghi, Vancouver (CA); Mohamed Osama Ahmed, Vancouver (CA); Edward James Smith, Toronto (CA); Vineeth Bhaskara, Montreal (CA); Mengyao Zhai, Vancouver (CA); Gregory Peter Mori, Burnaby (CA); Behrooz Noorizadeh, Vancouver (CA); Vineel Nagisetty, Vancouver (CA); Frederick Tung, North Vancouver (CA); Peter Forsyth, Waterloo (CA); Thibaut Durand, Vancouver (CA); Alexander Pashevich, Vancouver (CA); Nene Azu, Vancouver (CA); Alexander Scott, Toronto (CA); Keith Lacy, Brooklin (CA); Ankur Agarwal, Oakville (CA); Gopala Krishnan Narayanan, Mississauga (CA)

(21) Appl. No.: 19/091,539

(22) Filed: Mar. 26, 2025

(30) Foreign Application Priority Data
Mar. 17, 2025 (CA) 3268008

(51) Int. Cl. G06Q 40/03; G06N 3/045

(52) U.S. Cl. CPC G06Q 40/03; G06N 3/045

(57) ABSTRACT

One or more computer processors are used to generate an estimate of a credit capacity of a client. Financial data relating to the client is received. The financial data is input to one or more trained machine learning models. The one or more trained machine learning models are used to generate, based on the financial data, the estimate of the credit capacity.

### FIELD

The present disclosure relates to machine learning and in particular to methods and systems for generating a credit capacity estimate, as well as methods and systems for training machine learning models to generate credit capacity estimates.

### BACKGROUND

Adjudicating loans is challenging because it requires balancing risk assessment with customer needs. Lenders must analyze complex financial data, including credit history, income stability, and debt levels, to determine a borrower's ability to repay. This involves reviewing credit scores, payment histories, and outstanding liabilities to assess financial behavior and predict future repayment capacity. While debt-to-income ratios and other financial indicators help lenders gauge whether a borrower can handle additional credit without becoming overleveraged, the complexity of the analysis increases when considering fluctuating income sources, or applicants with limited credit history.

### SUMMARY

According to a first aspect of the disclosure, there is provided a method of generating an estimate of a credit capacity of a client, comprising using one or more computer processors to: receive financial data relating to the client; input the financial data to one or more trained machine learning models; and use the one or more trained machine learning models to generate, based on the financial data, the estimate of the credit capacity.

The one or more trained machine learning models may include a trained neural network. Inputting the financial data may comprise: generating, using the financial data, concatenated feature vectors; and inputting the concatenated feature vectors to the trained neural network.

The neural network may be a multi-layer perceptron.

The one or more trained machine learning models may include one or more trained decision trees. Inputting the financial data may comprises: generating, using the financial data concatenated feature vectors; and inputting the concatenated feature vectors to the one or more trained decision trees.

Inputting the financial data may comprise: generating, using the financial data, one or more monotonic feature vectors and one or more non-monotonic feature vectors; and inputting: the one or more monotonic feature vectors and the one or more non-monotonic feature vectors to a first set of layers of a neural network of the one or more trained machine learning models; and the one or more non-monotonic feature vectors but not the one or more monotonic feature vectors to a second set of layers of the neural network.

Generating the estimate may comprise: generating, using the first set of layers and based on the one or more monotonic feature vectors and the one or more non-monotonic feature vectors, a first output; generating, using the second set of layers and based on the one or more non-monotonic feature vectors, a second output; and generating the estimate based on the first and second outputs.

Inputting the financial data my comprise inputting the financial data to a trained neural additive machine learning model of the one or more trained machine learning model. Generating the estimate may comprise generating the estimate using the trained neural additive machine learning model.

The financial data may comprise: transaction data comprising time series data representing discrete transactions executed by the client, wherein each discrete transaction is associated with a respective transaction type; and client attribute data representative of one or more financial records of the client.

Inputting the financial data may comprise: receiving a transaction embedding vector characterizing a distribution of the discrete transactions with the transaction types; generating, using the client attribute data, one or more client attribute data feature vectors; concatenating the transaction embedding vector with the one or more client attribute data feature vectors; and inputting the concatenated vectors to the one or more trained machine learning models.

Inputting the financial data may comprise: inputting the transaction data to a first trained machine learning model of the one or more trained machine learning models; and inputting the client attribute data to a second trained machine learning model of the one or more trained machine learning models. Generating the estimate may comprise: using the first machine learning model to generate, based on the transaction data, a first output; using the second machine learning model to generate, based on the client attribute data, a second output; and generating the estimate based on the first and second outputs.

Inputting the transaction data to the first trained machine learning model may comprise: receiving a transaction embedding vector characterizing a distribution of the discrete transactions with the transaction types; and inputting the transaction embedding vector to the first trained machine learning model.

Receiving the transaction embedding vector may comprise: generating the transaction embedding vector by: inputting the transaction data to a trained representation learning machine learning model; and generating, using the trained representation learning machine learning model, the transaction embedding vector.

Inputting the client attribute data to the second trained machine learning model may comprise: generating, using the client attribute data, one or more client attribute data feature vectors; and inputting the one or more client attribute data feature vectors to the second trained machine learning model. Generating the estimate may comprise: generating, using the first trained machine learning model and based on the transaction embedding vector, a first output; generating, using the second trained machine learning model and based on the one or more client attribute data feature vectors, a second output; and generating the estimate based on the first and second outputs.

Generating the estimate based on the first and second outputs may comprise linearly combining the first and second outputs.

Linearly combining the first and second outputs may comprise multiplying the first output with the second output.

According to a further aspect of the disclosure, there is provided a non-transitory computer-readable medium storing computer program code configured, when executed by one or more processors, to cause the one or more processors to perform a method of generating an estimate of a credit capacity of a client, comprising: receiving financial data relating to the client; inputting the financial data to one or more trained machine learning models; and using the one or more trained machine learning models to generate, based on the financial data, the estimate of the credit capacity.

According to a further aspect of the disclosure, there is provided a method of training one or more machine learning models to generate an estimate of a credit capacity of a client, comprising using one or more computer processors to: receive financial data relating to different clients; receive credit limit data representative of loans accepted by the clients; receive performance data representative of how well each client met repayment obligations associated with each loan accepted by the client; and train the one or more machine learning models, using the financial data, the credit limit data, and the performance data to generate an estimate of a credit capacity of a client in response to the one or more machine learning models receiving an input comprising financial data relating to the client.

The financial data may comprise transaction data including, for each client, time series data representing discrete transactions executed by the client, wherein each discrete transaction is associated with a respective transaction type. The training may comprise: for each client, receiving a transaction embedding vector characterizing a distribution of the discrete transactions executed by the client with the transaction types; and training the one or more machine learning models using each transaction embedding vector, the credit limit data, and the performance data.

The financial data may comprise client attribute data representative of one or more financial records of the clients. The training may comprise: generating, using the client attribute data, one or more client attribute feature vectors; and training the one or more machine learning models using the one or more client attribute feature vectors, the credit limit data, and the performance data.

The training may comprise, during the training, applying a loss function that: for each client that exhibits good performance, increases a credit capacity of the client; and for each client that exhibits poor performance, decreases a credit capacity of the client.

The training may comprise: generating, using the financial data, financial data feature vectors; and during the training, applying a loss function that increases a monotonicity of credit capacity estimates output by the one or more machine learning models for monotonic financial data feature vectors that are input to the one or more machine learning models.

The training may comprise: identifying a desired credit capacity distribution; and during the training, applying a loss function that calibrates credit capacity estimates output by the one or more machine learning models to the credit capacity distribution.

According to a further aspect of the disclosure, there is provided a non-transitory computer-readable medium storing computer program code configured, when executed by one or more processors, to cause the one or more processors to perform a method of generating an estimate of a credit capacity of a client, comprising: receiving financial data relating to different clients; receiving credit limit data representative of loans accepted by the clients; receiving performance data representative of how well each client met repayment obligations associated with each loan accepted by the client; and training the one or more machine learning models, using the financial data, the credit limit data, and the performance data to generate an estimate of a credit capacity of a client in response to the one or more machine learning models receiving an input comprising financial data relating to the client.

This summary does not necessarily describe the entire scope of all aspects. Other aspects, features, and advantages will be apparent to those of ordinary skill in the art upon review of the following description of specific embodiments.

### DRAWINGS

Embodiments of the disclosure will now be described in detail in conjunction with the accompanying drawings of which:

FIG. 1 is a schematic diagram of a method of training a neural network to generate a credit capacity estimate, according to an embodiment of the disclosure;

FIG. 2 is a first schematic diagram of a method of training a neural network, using different loss functions, to generate a credit capacity estimate, according to an embodiment of the disclosure;

FIG. 3 is a schematic diagram of an architecture of a multi-layer perceptron, according to an embodiment of the disclosure;

FIG. 4 is a schematic diagram of a two-stream multi-layer perceptron being used to separately process monotonic and non-monotonic feature vectors, according to an embodiment of the disclosure;

FIG. 5 is a schematic diagram of a neural additive machine learning model used to generate a credit capacity estimate, according to an embodiment of the disclosure;

FIG. 6 is a schematic diagram of a method of training a representation machine learning model to generate a transaction embedding vector, according to an embodiment of the disclosure;

FIG. 7 is a schematic diagram of a method of generating a credit capacity estimate using a pair of neural networks, according to an embodiment of the disclosure;

FIG. 8 is a first schematic diagram of a method of generating a credit capacity estimate using a pair of neural networks including a representation learning model, according to an embodiment of the disclosure;

FIG. 9 is a second schematic diagram of a method of generating a credit capacity estimate using a pair of neural networks including a representation learning model, according to an embodiment of the disclosure; and

FIG. 10 is a schematic diagram of a computer system that may be used to train any of the machine learning models described herein, according to an embodiment of the disclosure

### DETAILED DESCRIPTION

The present disclosure seeks to provide novel methods and systems for generating credit capacity estimates and training machine learning models to generate credit capacity estimates. While various embodiments of the disclosure are described below, the disclosure is not limited to these embodiments, and variations of these embodiments may well fall within the scope of the disclosure which is to be limited only by the appended claims.

Generally, described herein are various machine learning models and methods that may be used to estimate a client's capacity for debt. This capacity can encompass various forms, such as credit limits, mortgage capacity, or any generic loan amount. The capacity value that is produced may be used, for example, to assist a financial institution determine the amount of credit the institution may be comfortable extending to the client in question. According to various embodiments of the disclosure, the framework leverages a machine learning-based solution trained to predict a capacity value based on a client's past financial behavior. This financial behavior may include a client's historical transaction behavior (i.e., data representing transactions that the client has executed, as well as what types of transactions the client engaged in) as well as the client's credit history and any other suitable attributes relating to the client. For example, the neural network may learn from a large collection of past loans and delinquencies to make accurate predictions. The machine learning solutions described herein may be used to aid in adjudicating loans across many applications within the financial institution. Using a data-driven approach to help adjudicate loans at the bank may replace the rules and heuristic-based approaches used in the past. By taking a data-driven approach to learning a client's debt capacity, which considers a large number of data sources, users of the trained machine learning models can make more personalized decisions regarding their clients. This allows for far more accurate and fine-grained decisions concerning the loans being issued, thereby increasing revenue and lowering risk.

Generally, throughout this disclosure, credit capacity refers to an amount of a loan or credit that a client is able to accept without defaulting within a predetermined amount of time. The credit capacity may be generated in various different forms and may be for example a value of a monthly installment, such as a monthly mortgage payment, or any other sum that must be repaid within a predetermined amount of time.

Generally, embodiments of the disclosure are directed at various different machine learning models that may be used to generate an estimate of a client's credit capacity. According to some embodiments, input features representing the client's financial behavior are provided to a machine learning model, such as a neural network, to generate the estimate of the credit capacity. The parameters of the neural network may be determined by training the neural network according to a learning objective that specifies the desired properties of the model.

A challenge faced in the development of these models is the absence of ground truth-labels for a client's capacity, to act as a target during training. In particular, the only available training data comprises attributes related to the client's financial behavior, their loan details, and their performance indicators/labels. Performance indicators/labels may include, for example, a number of days that the client is delinquent, or may indicate whether or not the client defaulted on the loan. From only this data, their true credit capacity must be estimated. However, what is known is that if a client exhibited poor performance (e.g., they defaulted on their loan or were strongly delinquent), then the loan amount is an upper bound of the client's capacity. Similarly, if a client exhibited good performance (e.g., they did not default on their loan or were only minimally or not at all delinquent), then the loan amount is a lower bound of the client's capacity.

By using historical financial data relating to the client, including a history of loans offered to the client and their associated performance labels after a specified amount of time (i.e., whether, for a given loan, the client exhibited good or poor performance), the target in the learning objective function may be calculated during training. In other words, since the ground-truth capacity is unknown, the approach taken to train the various machine learning models described herein is to learn the neural network parameters by optimizing novel objective functions. This aims to maximize the number of good-performing (e.g., non-defaulting or minimally delinquent) clients with predicted capacities higher than their respective loan amounts while minimizing the number of poor-performing (e.g., defaulting or delinquent) clients with predicted capacities below their respective loan amounts. In addition, one or more regularizers may be included in the objective function to improve calibration, interpretability, and generalization.

During model inference, details of a loan and the client's performance indicators/labels are not required; only the input features are used to predict the credit capacity. For example, according to some embodiments of the disclosure, each client is represented by a set of input features “x”. These features are passed to a neural network to generate a predicted capacity “f(x, Θ)” which is a function of the input features x and the neural network parameters Θ. The training procedure tunes Θ by optimizing the proposed objective function. Once this neural network for predicting capacity has been trained (i.e., the parameters Θ are determined), the neural network can be used with the input features of new clients to predict their respective credit capacities.

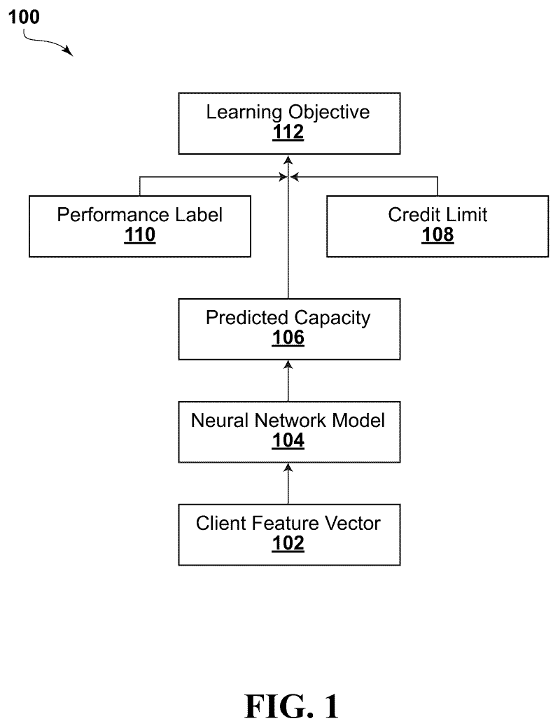

Turning to FIG. 1, there is shown a schematic diagram of a method 100 of training a neural network to generate a credit capacity estimate, according to a first embodiment of the disclosure. As can be seen, input features 102 representative of the client's financial history (including, for example, transaction data and credit data) are input to a neural network 104, the training of which is described in further detail below. Input features 102 may be generated using any suitable method, such as, but not limited to, vectorization. Neural network 104 processes input features 102 and generates an estimate of the client's credit capacity 106 based on the model's parameters. These parameters are adjusted during the training process to optimize an objective function 112, based on performance labels 110 and credit limits 108 (i.e., loan amounts).

Objective function 112 is defined based on performance labels 110 and credit limits 108. In particular, and as noted above, performance labels 110 may indicate whether or not a client defaulted for a given loan (or, for example, for how long a client was delinquent), and credit limits 108 are indicative of the loan amounts. In the case of a mortgage, the loan amount may be defined as a monthly mortgage payment. For an abstract loan, the loan amount may be defined as the maximum repayment amount that is due at regular intervals.

The definition of poor performance can vary differently for different applications and business needs. In the case of predicting a credit limit, poor performance may be defined as having a write-off label within two years of acquiring the loan. For predicting a maximum monthly mortgage payment, poor performance may be defined as at least 60 days of delinquency after 12 months, although other timescales may be used. For an abstract loan, poor performance may be defined as failure to meet the debt obligation for a time period T1 over the horizon T2 of the loan considered, where T2>=T1.

The learning objective for the framework can be divided into two main components: the capacity objective and the regularizers. As noted above, the goal of the capacity objective is to maximize the number of good-performing clients with predicted capacities higher than their respective loan amounts while maximizing the number of poor-performing clients with predicted capacities below their respective loan amounts. In addition, one or more of the following regularizers may be introduced to the learning objective to improve its interpretability and generalization.

According to some embodiments, an objective function generally pushes the learned capacity model to maximize the credit capacity given to good-performing clients and minimize the credit capacity given to poor-performing clients. However, this may not be desirable since “good-performing” and “poor-performing” are relative to the loan amount and are not necessarily an accurate description of the client's actual capacity to take on a maximum or minimum loan amount. Instead, the learned capacity model should provide a smooth distribution of capacities across the full range of possible loan amounts. Since ground-truth capacity values are not an element of the training dataset, a regularizer towards a proxy target can be added. With this regularizer, the predicted capacity distribution resembles the target proxy and extreme capacities are avoided. In this case, the loss function may be defined as a statistical distance loss between the distribution of predicted capacities and the distribution of proxy targets. Examples of these statistical distance losses include the Kullback-Leibler Divergence, the Jensen-Shannon Divergence, and the Total Variation Distance. By matching predicted capacities to proxy targets at a distribution level, rather than an individual level, the model can produce distributions of capacities that do not skew too heavily towards extreme values while also allowing the placement of capacities for individual clients to be optimized within the corresponding distribution.

According to further embodiments, inductive biases can be introduced during the training process to encourage the space of produced models to possess certain desirable properties. This can allow for the identification of key features whose increase should consistently induce a positive or negative change in the predicted capacity. These relationships between inputs and the model's predicted outputs are known as either positive or negative monotonicity. Due to factors such as noise in the input data and irregular network behavior, these monotonicity relationships may not be fully realized without direct intervention, and their absence may lead to poor generalization and stability. To encourage these behaviors to develop throughout training, an inductive bias in the form of a monotonic loss can be introduced.

To compute this monotonic loss, at every training iteration, the input feature vectors may be concatenated with a set of random feature vectors such that the resulting concatenated vector captures the general data distribution the model will observe at inference. The vector is passed through the network, and the network predicts the capacities resulting from these inputs. By taking the gradient of the predicted capacities with respect to the monotonic features in the input, the network's response to their changes can be observed. A penalty term can then be created wherein the network is penalized if this response violates the monotonic relationship that is wished to be observed.

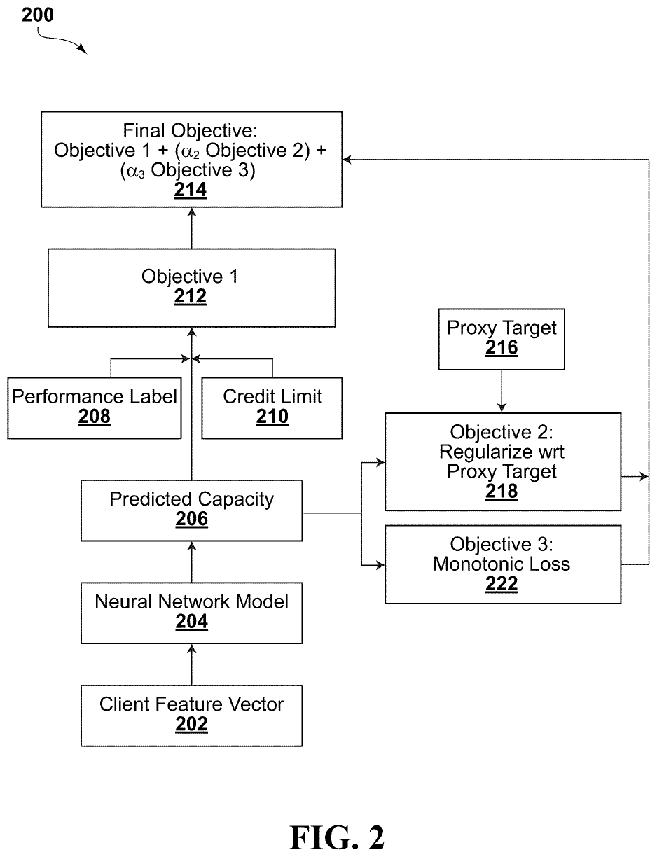

The final form of learning objective 112 is then a weighted sum of the capacity objective and the various regularizers that are used. For example, FIG. 2 illustrates input feature vectors 202 being passed through a neural network 204 in training. Network 204 outputs predicted capacities 206 and adjusts predicted capacity outputs 206 in accordance with an objective function 212 which is defined according to performance labels 208 (i.e., delinquency data) and credit limits 210 (i.e. loan amounts). Regularizers (including capacity regularizer 218 and monotonic loss regularizer 222) are also applied during the training and bias the output of network 204 toward a final objective function 214 which is a linear combination of objective function 212 and weighted contributions from the regularizers 218 and 222. In the example of FIG. 2, capacity regularizer 218 uses a proxy target 216 as described above.

According to some embodiments, there are two sources of data which can be leveraged to train the machine learning model. In particular, the financial data may include client attribute data aggregated over a client's financial history, as well as transaction data representative of historical transactions executed by the client. The client attribute data (which may be in tabular form) is generally representative of financial information/records of the client, and may include in particular credit history data representative of the client's credit history and financial health, including, but not limited to, credit payments, default history, revolving balances, delinquencies, and number of credit accounts open. Further attributes may include the client's income and the amount of money in any savings account. The transaction data, as noted above, may comprise time series data representing discrete transactions executed by the client, with each discrete transaction being associated with a respective transaction type. For example, the transaction data may include transaction values as a function of transaction type (e.g., point-of-sale purchases, online purchases, withdrawals, any credit card or checking account transaction, etc.).

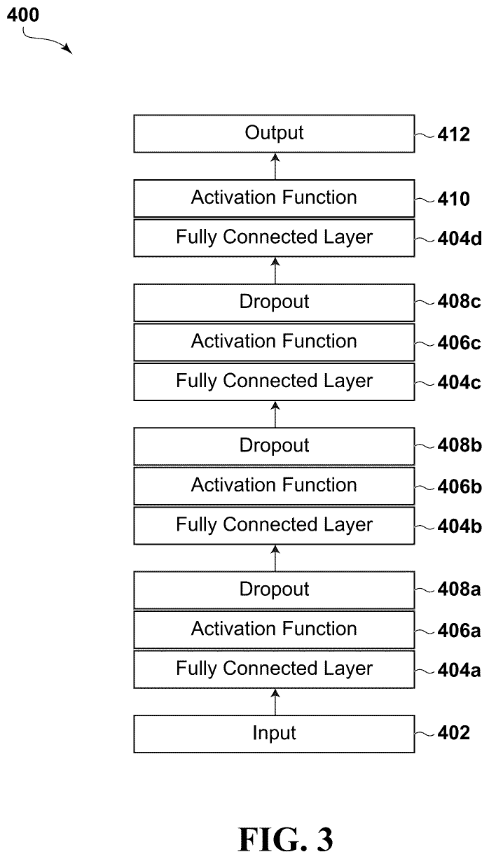

Any suitable neural network variant or architecture may be used when training to introduce interpretability and inductive biases to the training process. For example, according to the embodiment shown in FIG. 3, a multi-layer perceptron 400 may be used, wherein multi-layer perceptron 400 receives concatenated input features 402 and predicts directly the capacity estimate based on input features 402. As can be seen in FIG. 3, concatenated input features 402 are received at a first fully connected layer 404a connected to a first activation function 406a which his connected to a first dropout layer 408a. This interconnection of layers is repeated one or more times across multi-layer perceptron 400, before the output of fully connected layer 404d is passed to an activation function 410 which generates the credit capacity estimate 412.

According to some embodiments, a certified monotonic neural network may be used, wherein the capacity prediction may be pushed to be monotonic with respect to certain input features. This makes the model's decisions with respect to certain input features more interpretable and may improve generalization. Embodiments of the disclosure may use any of the certified monotonic neural networks described in US Patent Application Publication No. 2023/0094355, filed on Sep. 13, 2022, and titled “System and method for enforcing monotonicity in a neural network architecture”, herein incorporated by reference in its entirety.

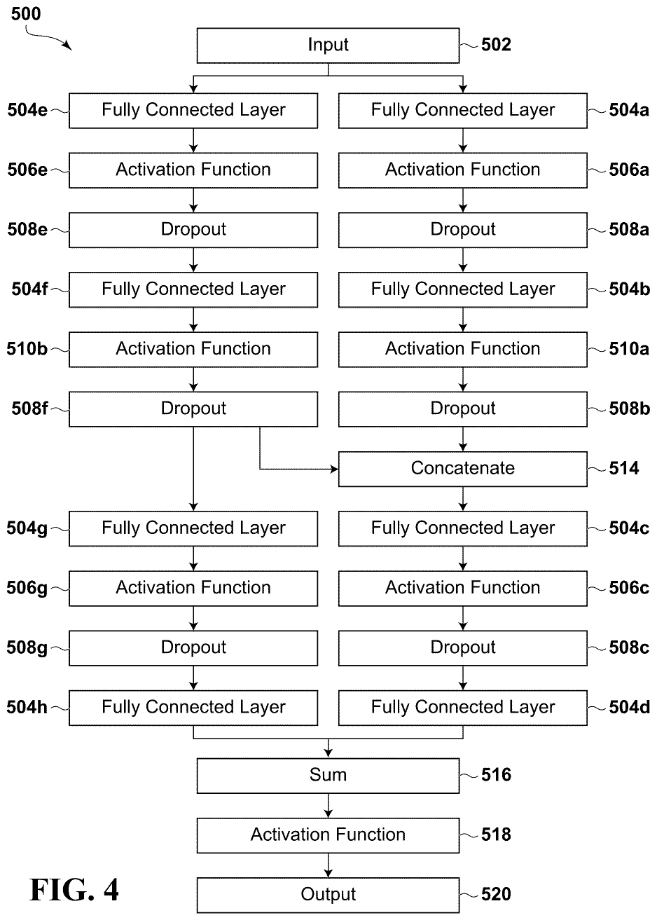

As can be seen in FIG. 4 which shows such a certified monotonic neural network, the input features 502 are divided into monotonic and non-monotonic input features and are processed using different streams of the network. For example, a two-stream multi-layer perceptron 500 may be used, with multiple fully connected layers (504a-504h), activation functions such as activation functions (506a, 506c, 506e, 506g), and dropout layers (508a, 508b, 508c, 508e, 508f, 508g) in each, as seen in FIG. 4. Each stream further includes a further respective activation function 510b, 510a. The first stream (on the left-hand side) operates over only the non-monotonic input features 502, and the second stream (on the right-hand side) operates over all input features 502. The streams are interconnected to allow information from the first stream to interact with information in the second stream. In particular, the output of dropout layer 508f is passed to fully connected layer 504g as well as being concatenated at 514 with the output of dropout layer 508b. The outputs of fully connected layers 504h and 504d are summed at 516 and then the sum is passed to an activation function 518 which generates the credit capacity estimate 520.

According to some embodiments, a neural additive model (NAM) may be used to generate the credit capacity estimate. Examples of NAMs that may be used are further described in Neural Additive Models: Interpretable Machine Learning with Neural Nets, by Agarwal, R, et al, 35th Conference on Neural Information Processing Systems (NeurIPS 2021), https://arxiv.org/abs/2004.13912, herein incorporated by reference in its entirety. A neural additive model combines some of the expressivity of deep neural networks with the inherent explainability of generalized additive models (GAMs). A GAM is model that has the following form:

$$f ( x ) = β + {\sum }_{i = 1}^{K} {f}_{i} ( {x}_{i} )$$

where K is the number of features, β is a bias, and each fᵢ is a univariate shape function. NAMs are a special form of GAMs where each fᵢ is restricted to be a neural network. NAMs learn a linear combination of networks that each attend to a single input feature. Each fᵢ is a neural network, called feature neural network (FeatureNN), that takes a single feature as its input and outputs the prediction associated with this feature. An activation function layer (e.g., a rectified linear unit layer or a sigmoid) can be added after the sum to adapt the model output to a specific task. These networks are trained jointly using backpropagation and can learn arbitrarily complex shape functions. Because each feature is handled independently by a learned shape function parameterized by a neural network, it is possible to obtain a full view of the model by simply graphing the individual shape functions (i.e., by plotting fᵢ(xᵢ) vs. xᵢ). These shape function plots describe exactly how NAMs compute a prediction.

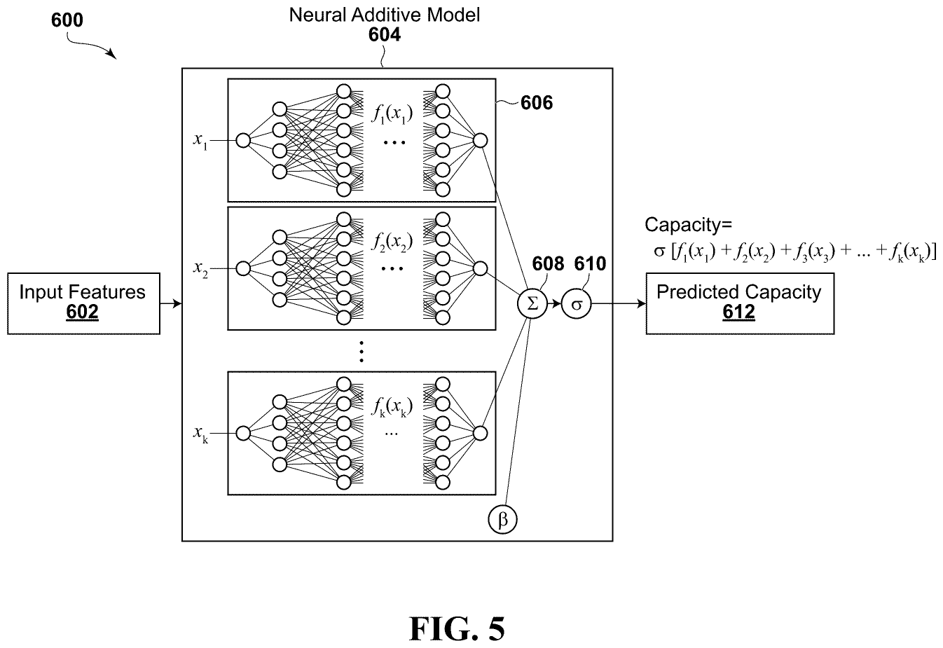

FIG. 5 is a schematic diagram illustrating the use of a GAM to generate a credit capacity estimate. As can be seen, input features 602 representative of the client's financial data are input to each neural network 606 in a set 604 of neural networks 606. The outputs of neural networks 606 are summed 608 and the sum is then passed to an activation function 610. The output of activation function 610 is the predicted capacity 612.

According to some embodiments, a neural basis model (NBM) may be used. A neural basis model is a type of neural additive model with shared weights. A neural basis model may scale better to large-scale data with high-dimensional features, especially when features are sparse. Examples of NBMs that may be used are further described in Neural Basis Models for Interpretability, by Radenovic, F, et al, 36th Conference on Neural Information Processing Systems (NeurIPS 2022), https://arxiv.org/abs/2205.14120, herein incorporated by reference in its entirety.

According to some embodiments, a decision tree or an ensemble of decision trees (e.g., random forests, gradient boosted trees) may be also used instead of neural networks.

A further consideration when designing models to generate credit capacity estimates is how to combine the client's aggregated attribute data with the transaction data which is generally of a more granular nature. According to some embodiments, the transaction data may be converted into a fixed-size input by using a trained transaction embedding model may be used. According to some embodiments, the trained transaction embedding model may be any of the trained transaction embedding models described in Patent Cooperation Treaty Application Serial No. PCT/CA2025/050052, titled “Application of Representation Learning to Discrete Event Sequences Across Discrete Domains”, filed on Jan. 14, 2025, and herein incorporated by reference in its entirety.

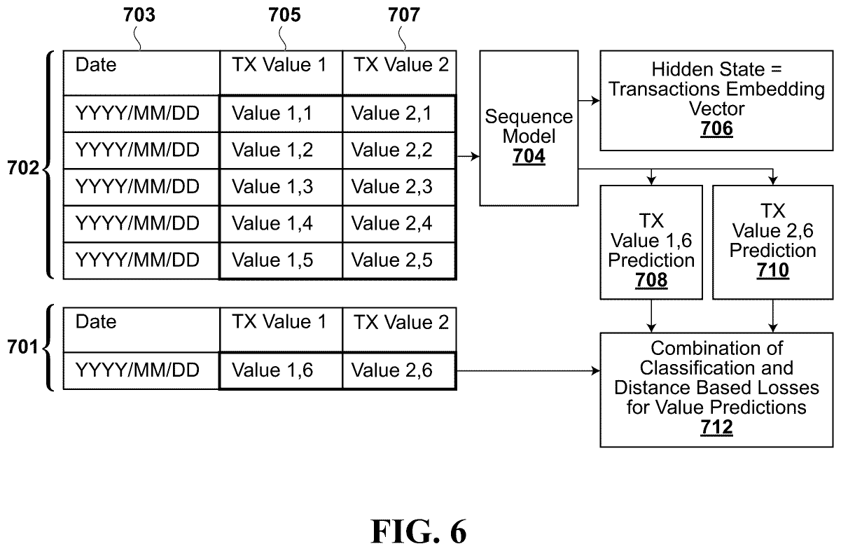

FIG. 6 is a schematic diagram illustrating the training of transaction embedding model to generate a transaction embedding vector representing transaction data. As can be seen, the transaction data 702 used for the training includes discrete historical transactions executed by different clients. Each transaction is associated with a corresponding date 703 and transaction features 705, 707 describing details of the transactions. The transaction features may include, for example a feature indicative of a type of the transaction, such as a transaction code, and a feature indicative of a sum of the transaction. Transaction data 702 is passed to transaction embedding model 704 (which may be a sequence model). Transaction embedding model 704 generates, based on the training data, a transaction embedding vector 706 which characterizes a distribution of the discrete transactions with the different details of the transactions as represented by transaction features 705, 707. Transaction embedding model 704 further generates a prediction for future transaction features 708 and 710. Training transaction embedding model 404 comprises predicting future transaction features 708 and 710 from the observed transaction data 702 and using losses 712 between them as well as true ground-truth transaction data 701 to bias the model towards correct predictions.

The transaction embedding vector may then be combined with the client attribute data according to various different ways. For example, according to some embodiments, feature vectors are generated based on the client attribute data, and the transaction embedding vector may be concatenated with the client attribute feature vectors. The concatenated vectors may then be input to any of the above-described machine learning models.

According to some embodiments, a two-streamed approach may be used in which the transaction embedding vector is input to a first machine learning model and the client attribute feature vectors are input to a second machine learning model. The respective outputs of the machine learning models are then combined to make the final prediction. According to this approach, the contributions from both sources (i.e., from the client's transaction data, and the client's attribute data) can be understood in isolation. The particular machine learning models that are used to process the transaction embedding vector and the client attribute feature vectors may be any of the different neural network described above.

The manner in which the outputs of the machine learning models are combined may vary based on need. For example, according to embodiments, the separate outputs may undergo a linear combination, such as addition or multiplication. According to some embodiments, one machine learning model may predict a capacity value, and the other machine learning model may predict a multiplier to be applied to the predicted capacity value.

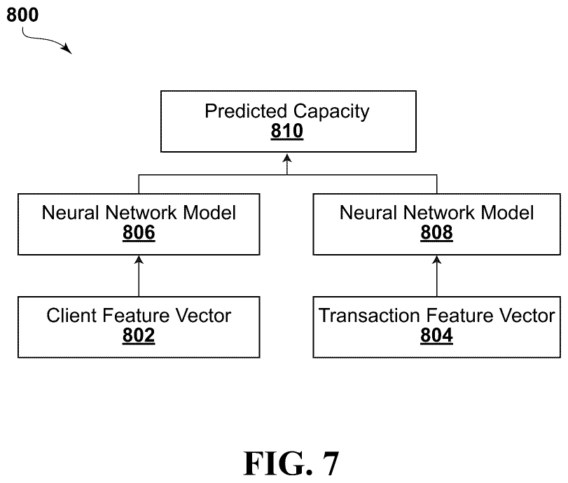

Turning to FIG. 7, there is shown a schematic diagram of a two-stream approach for generating a credit capacity estimate. In particular, client attribute feature vectors 802 are processed by a first neural network 806 (which may be any of the above-described neural networks) and a transaction embedding vector 804 (for example, a transaction embedding vector generated using the transaction embedding model described above in connection with FIG. 6) is processed by a second neural network 808 (which may be any of the above-described neural networks). The outputs of neural networks 806, 808 are combined to produce a final estimate 810 of the client's credit capacity. As described above, according to this approach, the respective contributions to the client's overall credit capacity from each of the client's transaction history and attribute data (for example their credit history) may be understood in isolation.

According to some embodiments, instead of inputting a single transaction embedding vector to neural network 808, multiple transaction feature vectors may be input to neural network 808. For example, for each transaction type, a corresponding transaction feature vector may be generated based on the specific transactions associated with the transaction type. The resulting transaction feature vectors each characterize a distribution of the transactions as a function of their respective transaction type, and these transaction feature vectors are input to neural network 808. This approach may allow for greater insight into the client at the cost of greater model instability and lower interpretability.

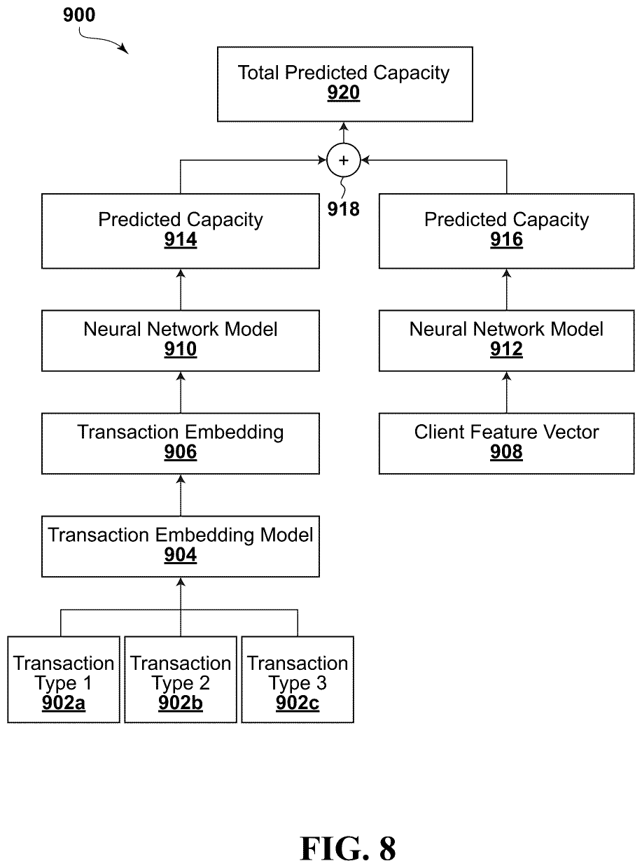

Turning to FIG. 8, there is shown a schematic diagram of a method of generating a client's credit capacity based on the method shown in FIG. 7. According to this embodiment, a trained transaction embedding model 904 (as described above) is used to process the transaction data and generate, based on the distribution of transactions and associated transaction types 902a, 902b, 902c, a transaction embedding vector 906 that characterizes the distribution of the discrete transactions with the transaction types. Transaction embedding vector 906 is passed to a first neural network 910 trained to produce a first credit capacity estimate 914. In parallel, based on the client's attribute data, client attribute feature vectors are generated and input to a second neural network 912 trained to produce a second credit capacity estimate 916. Outputs 914 and 916 of neural networks 910 and 912 are then combined to produce a final overall estimate 920 of the client's credit capacity. As described above, outputs 914 and 916 may be combined using any linear combination method, such as addition or multiplication. In the case of FIG. 8, outputs 914 and 916 are summed to produce credit capacity estimate 920.

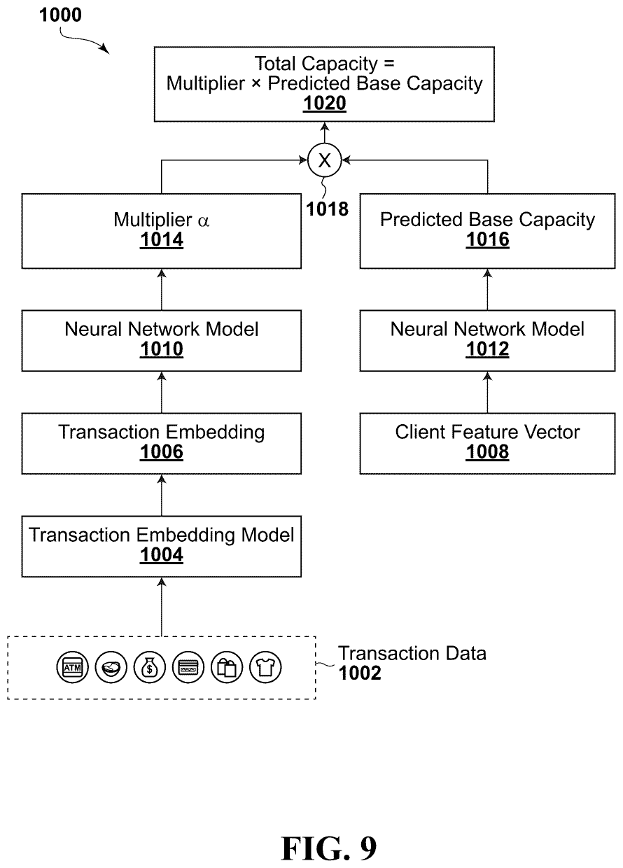

Turning to FIG. 9, another schematic diagram of a method of generating a client's credit capacity is shown. FIG. 9 is similar to FIG. 8 and the same features are referenced using similar reference numbers. However, in the embodiment of FIG. 9, neural network 1010 (which processes transaction embedding vector 1006) is trained to output a multiplier 1014 that is applied to the output 1016 of neural network 1012 (which processes client attribute feature vectors 1008). The multiplier may be configured based on some constraints. For example, if the multiplier is constrained to be greater than or equal to 1, the transaction data can only contribute positively to the predicted base capacity. On the other hand, if the multiplier is constrained to be less than 1, the transaction data can only contribute negatively to the predicted base capacity. It is also possible to set lower and upper bounds for the multiplier to specify the minimum and maximum potential contributions, respectively, of the transaction data to the predicted base capacity.

According to some embodiments, the outputs of both streams may be constrained to a certain credit capacity distribution. For example, the outputs of both streams may be restricted to a certain maximum, or the multiplier may be limited to a given range of values, or the addition may have to be positive.

Embodiments of the disclosure are therefore directed at methods of training machine learning models to generate credit capacity estimates based on financial data. Embodiments of the disclosure are further directed at such trained machine learning models, and at systems configured to train machine learning models in such a manner, as well as computer-readable media storing machine learning models trained in such a manner. Embodiments of the disclosure are further directed to the use of trained machine learning models trained in such a manner. For example, the trained neural networks described herein may be used by banks or other financial institutions to efficiently and less resource-intensively adjudicate the offering of loans, such as mortgages.

As can be seen from the above description, training machine learning models to generate credit capacity estimates based on financial data represents significantly more than merely using categories to organize, store and transmit information and organizing information through mathematical correlations. The training of machine learning models to generate credit capacity estimates based on financial data is in fact an improvement to the technology of machine learning, as it provides for a machine learning model that may more consistently make accurate decisions given various different contexts/environments it is presented with. Moreover, although the technology can be applied across a wide range of scenarios, the particular scenario in which the technology is applied does not change the fundamental nature of the technology described and claimed herein, which is entirely confined to machine learning applications.

The present technology may be embodied within a system, a method, a computer program product or any combination thereof. The computer program product may include a computer-readable storage medium or media having computer-readable program instructions thereon for causing a processor to carry out aspects of the present technology. The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present technology may be assembler instructions, instruction-set-architecture (ISA) instructions, machine instructions, machine dependent instructions, microcode, firmware instructions, state-setting data, or either source code or object code written in any combination of one or more programming languages, including an object-oriented programming language or a conventional procedural programming language. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by using state information of the computer-readable program instructions to personalize the electronic circuitry, in order to implement aspects of the present technology.

Aspects of the present technology have been described above with reference to flowchart illustrations and/or block diagrams of methods, apparatus (systems) and computer program products according to various embodiments. In this regard, the flowchart and block diagrams in the drawings illustrate the architecture, functionality, and operation of possible implementations of systems, methods and computer program products according to various embodiments of the present technology. For instance, each block in the flowchart or block diagrams may represent a module, segment, or portion of instructions, which comprises one or more executable instructions for implementing the specified logical function(s). It should also be noted that, in some alternative implementations, the functions noted in the block may occur out of the order noted in the drawings. For example, two blocks shown in succession may, in fact, be executed substantially concurrently, or the blocks may sometimes be executed in the reverse order, depending upon the functionality involved. Some specific examples of the foregoing may have been noted above but any such noted examples are not necessarily the only such examples. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer-readable program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer-readable program instructions may also be stored in a computer-readable storage medium that can direct a computer, other programmable data processing apparatus, or other devices to function in a particular manner, such that the instructions stored in the computer-readable storage medium produce an article of manufacture including instructions which implement aspects of the functions/acts specified in the flowchart and/or block diagram block or blocks. The computer-readable program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

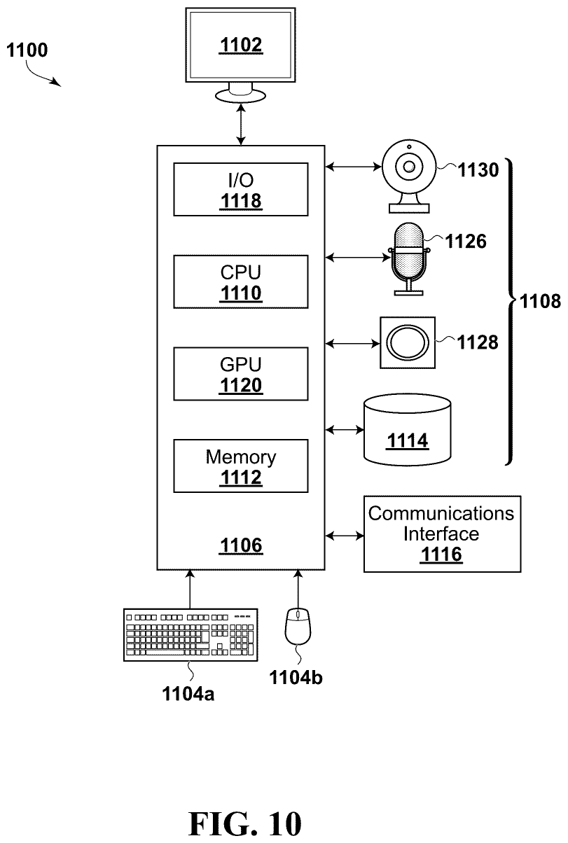

An illustrative computer system in respect of which the technology herein described may be implemented is presented as a block diagram in FIG. 10. The illustrative computer system is denoted generally by reference numeral 1100 and includes a display 1102, input devices in the form of keyboard 1104a and pointing device 1104b, computer 1106 and external devices 1108. While pointing device 1104b is depicted as a mouse, it will be appreciated that other types of pointing device, or a touch screen, may also be used.

The computer 1106 may contain one or more processors or microprocessors, such as a central processing unit (CPU) 1110. The CPU 1110 performs arithmetic calculations and control functions to execute software stored in an internal memory 1112, preferably random-access memory (RAM) and/or read only memory (ROM), and possibly additional memory 1114. The additional memory 1114 may include, for example, mass memory storage, hard disk drives, optical disk drives (including CD and DVD drives), magnetic disk drives, magnetic tape drives (including LTO, DLT, DAT and DCC), flash drives, program cartridges and cartridge interfaces such as those found in video game devices, removable memory chips such as EPROM or PROM, emerging storage media, such as holographic storage, or similar storage media as known in the art. This additional memory 1114 may be physically internal to the computer 1106, or external as shown in FIG. 10, or both.

The computer system 1100 may also include other similar means for allowing computer programs or other instructions to be loaded. Such means can include, for example, a communications interface 1116 which allows software and data to be transferred between the computer system 1100 and external systems and networks. Examples of communications interface 1116 can include a modem, a network interface such as an Ethernet card, a wireless communication interface, or a serial or parallel communications port. Software and data transferred via communications interface 1116 are in the form of signals which can be electronic, acoustic, electromagnetic, optical or other signals capable of being received by communications interface 1116. Multiple interfaces, of course, can be provided on a single computer system 1100.

Input and output to and from the computer 1106 is administered by the input/output (I/O) interface 1118. This I/O interface 1118 administers control of the display 1102, keyboard 1104a, external devices 1108 and other such components of the computer system 1100. The computer 1106 also includes a graphical processing unit (GPU) 1120. The latter may also be used for computational purposes as an adjunct to, or instead of, the (CPU) 1110, for mathematical calculations.

The external devices 1108 include a microphone 1126, a speaker 1128 and a camera 1130. Although shown as external devices, they may alternatively be built in as part of the hardware of the computer system 1100.

The various components of the computer system 1100 are coupled to one another either directly or by coupling to suitable buses.

The term “computer system”, “data processing system” and related terms, as used herein, is not limited to any particular type of computer system and encompasses servers, desktop computers, laptop computers, networked mobile wireless telecommunication computing devices such as smartphones, tablet computers, as well as other types of computer systems.

Thus, computer-readable program code for implementing aspects of the technology described herein may be contained or stored in the memory 1112 of the computer 1106, or on a computer usable or computer-readable medium external to the computer 1106, or on any combination thereof.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

The terms “coupled”, “coupling” or “connected” as used herein can have several different meanings depending on the context in which these terms are used. For example, as used herein, the terms coupled, coupling, or connected can indicate that two elements or devices are directly connected to one another or connected to one another through one or more intermediate elements or devices via a mechanical element depending on the particular context. The term “and/or” herein when used in association with a list of items means any one or more of the items comprising that list.

As used herein, a reference to “about” or “approximately” a number or to being “substantially” equal to a number means being within +/−10% of that number.

Use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

While the disclosure has been described in connection with specific embodiments, it is to be understood that the disclosure is not limited to these embodiments, and that alterations, modifications, and variations of these embodiments may be carried out by the skilled person without departing from the scope of the disclosure.

It is furthermore contemplated that any part of any aspect or embodiment discussed in this specification can be implemented or combined with any part of any other aspect or embodiment discussed in this specification.

1. A method of generating an estimate of a credit capacity of a client, comprising using one or more computer processors to:
receive financial data relating to the client, wherein the financial data comprises:
transaction data comprising time series data representing discrete transactions executed by the client, wherein each discrete transaction is associated with a respective transaction type; and
client attribute data representative of one or more financial records of the client;
input the financial data to one or more trained machine learning models, wherein inputting the financial data comprises:
inputting the transaction data to a first trained machine learning model of the one or more trained machine learning models; and
inputting the client attribute data to a second trained machine learning model of the one or more trained machine learning models; and
use the one or more trained machine learning models to generate, based on the financial data, the estimate of the credit capacity, wherein generating the estimate comprises:
using the first machine learning model to generate, based on the transaction data, a first output;
using the second machine learning model to generate, based on the client attribute data, a second output; and
generating the estimate based on the first and second outputs.

2. The method of claim 1, wherein:
the one or more trained machine learning models include a trained neural network; and
inputting the financial data comprises:
generating, using the financial data, concatenated feature vectors; and
inputting the concatenated feature vectors to the trained neural network.

3. The method of claim 2, wherein the neural network is a multi-layer perceptron.

4. The method of claim 1, wherein:
the one or more trained machine learning models include one or more trained decision trees; and
inputting the financial data comprises:
generating, using the financial data concatenated feature vectors; and
inputting the concatenated feature vectors to the one or more trained decision trees.

5. The method of claim 1, wherein:
inputting the financial data comprises:
generating, using the financial data, one or more monotonic feature vectors and one or more non-monotonic feature vectors; and
inputting:
the one or more monotonic feature vectors and the one or more non-monotonic feature vectors to a first set of layers of a neural network of the one or more trained machine learning models; and
the one or more non-monotonic feature vectors but not the one or more monotonic feature vectors to a second set of layers of the neural network; and
generating the estimate comprises:
generating, using the first set of layers and based on the one or more monotonic feature vectors and the one or more non-monotonic feature vectors, a first output;
generating, using the second set of layers and based on the one or more non-monotonic feature vectors, a second output; and
generating the estimate based on the first and second outputs.

6. The method of claim 1, wherein:
inputting the financial data comprises inputting the financial data to a trained neural additive machine learning model of the one or more trained machine learning model; and
generating the estimate comprises generating the estimate using the trained neural additive machine learning model.

7. (canceled)

8. (canceled)

9. (canceled)

10. The method of claim 1, wherein inputting the transaction data to the first trained machine learning model comprises:
receiving a transaction embedding vector characterizing a distribution of the discrete transactions with the transaction types; and
inputting the transaction embedding vector to the first trained machine learning model.

11. The method of claim 10, wherein receiving the transaction embedding vector comprises:
generating the transaction embedding vector by:
inputting the transaction data to a trained representation learning machine learning model; and
generating, using the trained representation learning machine learning model, the transaction embedding vector.

12. The method of claim 10, wherein:
inputting the client attribute data to the second trained machine learning model comprises:
generating, using the client attribute data, one or more client attribute data feature vectors; and
inputting the one or more client attribute data feature vectors to the second trained machine learning model; and
generating the estimate comprises:
generating, using the first trained machine learning model and based on the transaction embedding vector, a first output;
generating, using the second trained machine learning model and based on the one or more client attribute data feature vectors, a second output; and
generating the estimate based on the first and second outputs.

13. The method of claim 12, wherein generating the estimate based on the first and second outputs comprises linearly combining the first and second outputs.

14. The method of claim 13, wherein linearly combining the first and second outputs comprises multiplying the first output with the second output.

15. A non-transitory computer-readable medium storing computer program code configured, when executed by one or more processors, to cause the one or more processors to perform a method of generating an estimate of a credit capacity of a client, comprising:
receiving financial data relating to the client, wherein the financial data comprises:
transaction data comprising time series data representing discrete transactions executed by the client, wherein each discrete transaction is associated with a respective transaction type; and
client attribute data representative of one or more financial records of the client;
inputting the financial data to one or more trained machine learning models, comprising:
receiving a transaction embedding vector characterizing a distribution of the discrete transactions with the transaction types;
generating, using the client attribute data, one or more client attribute data feature vectors;
concatenating the transaction embedding vector with the one or more client attribute data feature vectors; and
inputting the concatenated vectors to the one or more trained machine learning models; and
using the one or more trained machine learning models to generate, based on the financial data, the estimate of the credit capacity.

16. A method of training one or more machine learning models to generate an estimate of a credit capacity of a client, comprising using one or more computer processors to:
receive financial data relating to different clients;
receive credit limit data representative of loans accepted by the clients;
receive performance data representative of how well each client met repayment obligations associated with each loan accepted by the client; and
train the one or more machine learning models, using the financial data, the credit limit data, and the performance data to generate an estimate of a credit capacity of a client in response to the one or more machine learning models receiving an input comprising financial data relating to the client.

17. The method of claim 16, wherein:
the financial data comprises transaction data including, for each client, time series data representing discrete transactions executed by the client, wherein each discrete transaction is associated with a respective transaction type; and
the training comprises:
for each client, receiving a transaction embedding vector characterizing a distribution of the discrete transactions executed by the client with the transaction types; and
training the one or more machine learning models using each transaction embedding vector, the credit limit data, and the performance data.

18. The method of claim 16, wherein:
the financial data comprises client attribute data representative of one or more financial records of the clients; and
the training comprises:
generating, using the client attribute data, one or more client attribute feature vectors; and
training the one or more machine learning models using the one or more client attribute feature vectors, the credit limit data, and the performance data.

19. The method of claim 16, wherein the training comprises, during the training, applying a loss function that:
for each client that exhibits good performance, increases a credit capacity of the client; and
for each client that exhibits poor performance, decreases a credit capacity of the client.

20. The method of claim 16, wherein the training comprises:
generating, using the financial data, financial data feature vectors; and
during the training, applying a loss function that increases a monotonicity of credit capacity estimates output by the one or more machine learning models for monotonic financial data feature vectors that are input to the one or more machine learning models.

21. The method of claim 16, wherein the training comprises:
identifying a desired credit capacity distribution; and
during the training, applying a loss function that calibrates credit capacity estimates output by the one or more machine learning models to the credit capacity distribution.

22. A non-transitory computer-readable medium storing computer program code configured, when executed by one or more processors, to cause the one or more processors to perform a method of generating an estimate of a credit capacity of a client, comprising:
receiving financial data relating to different clients;
receiving credit limit data representative of loans accepted by the clients;
receiving performance data representative of how well each client met repayment obligations associated with each loan accepted by the client; and
training the one or more machine learning models, using the financial data, the credit limit data, and the performance data to generate an estimate of a credit capacity of a client in response to the one or more machine learning models receiving an input comprising financial data relating to the client.
